(19) United States
(12) Patent Application Publication
(10) Pub. No.: US 2013/0065212 A1
(43) Pub. Date: Mar. 14, 2013

(54) Interactive online laboratory

(71) Applicants: Mats Selen, Tuscola, IL (US); Tim Stelzer, Urbana, IL (US)

(72) Inventors: Mats Selen, Tuscola, IL (US); Tim Stelzer, Urbana, IL (US)

(21) Appl. No.: 13/199,863

(22) Filed: Sep. 12, 2011

(51) Int. Cl. G09B 23/00

(52) U.S. Cl. 434/276

(57) ABSTRACT

A wireless sensor probe is used for performing experiments in an interactive laboratory. The probe may include a plurality of sensors for collecting experimental data during an experiment and a transmitter for wirelessly transmitting the collected data to a receiver module. The receiver module is adapted for transferring the data to a computer where a software component may process the data for presentation of the resultant processed data on a display substantially in real-time.

### FIELD OF THE INVENTION

The present invention generally relates to a laboratory kit including a wireless sensor probe for performing experiments within an interactive laboratory. In particular, the kit may collect data from an associated experimental environment for processing by a software component operating within the interactive laboratory.

### BACKGROUND OF THE INVENTION

Traditionally, educational courses include both a lecture component and a hands-on laboratory component. During the lecture component, a professor or a teacher may speak or lecture on an educational topic in front of a classroom of students. The laboratory component may include student hands-on experimentation conducted under the direction of an instructor or teaching assistant. Generally, the instructor or teaching assistant instructs the students and provides guidance as needed during the experiment. The instructor or teaching assistant may also provide educational and informative feedback and grades relating to the students' performance.

Laboratory components may, however, require significant costs and resources including expensive equipment such as computers, sensors, data acquisition software, and other complex hardware and software devices. Preparation and set up for laboratory components also require a dedicated and oftentimes highly-trained staff and large, as well as properly equipped rooms for housing the laboratory equipment.

In addition, the laboratory curriculum must be designed to match the needs of the educational course. For example, the instructors or teaching assistants must be trained in the proper teaching techniques and equipment operation for each laboratory section. In addition, the instructor or teaching assistant must be trained in the proper grading techniques for evaluating the students' performance and entering the grades into the course grade-book.

These requirements may be expensive and many colleges and universities do not have the resources to offer laboratory sections for each course. Students at these colleges and universities may therefore be precluded from obtaining hands-on laboratory experience in these environments.

A need therefore exists for a low-cost system that provides students a hands-on interactive laboratory experience.

### SUMMARY OF THE INVENTION

The present invention relates to an interactive laboratory kit for providing students a self-paced and hands-on experience for performing experiments. In general, the interactive laboratory kit provides a learning platform for students to perform multiple types of experiments at various locations. The interactive laboratory kit may include hardware components, such as a wireless sensor probe, a receiver module, and a storage mechanism, and a software component including software capable of implementing the laboratory experience.

The sensor probe may be a lightweight, portable, and wireless device used by a student for performing different laboratory experiments. The probe includes a plurality of sensors for sensing physical characteristics and other phenomena within the experimental environment and collecting experimental data associated with the sensed physical characteristics and phenomena during the course of a laboratory experiment. In one example, the plurality of sensors are capable of sensing and collecting data associated with various physical phenomena including acceleration data associated with the movement of the probe, magnetic field data associated with magnetic fields located proximate the probe, voltage data associated with an external voltage source connected to the probe, and the distance and position data associated with a probe relative to a particular location or object. Once phenomena is sensed and the data is collected, the sensor probe may transmit a signal containing the collected experimental data to the receiver module.

The receiver module may have a similar shape and size to that of the sensor probe and may be adapted to connect with a personal computer for transferring the signal containing the collected experimental data to the computer. The functions of the receiver module may also be handled by the personal computer.

The storage mechanism may store the software component and be adapted to connect with the personal computer. In one example, the storage mechanism may be a portable device, such as a USB flash drive and is adapted for insertion into or connection to the computer. In another example, the storage mechanism may be built directly into the personal computer, such as an internal hard drive.

The software component includes software stored at the storage mechanism and is adapted for implementing the interactive laboratory. In one example the software component includes software for executing a lesson application program capable of controlling different aspects of the interactive laboratory. For instance, the lesson application program may provide an interactive student interface for controlling a particular experiment and may provide guidance to the student throughout each aspect of an experiment. Via the interactive interface, the student may select, setup, and initiate a particular experiment or manipulate or analyze data presented during the course of the experiment. The lesson application program may also provide laboratory instructions, questions, and other informative data to the student during the course of the selected experiment.

The software component may also include software adapted for executing multiple sets of instructions at a computer for processing the collected experimental data and calculating different magnitudes and values associated with physical characteristics and phenomena encountered within the experimental environment. In one example, the software component is capable of calculating magnitudes associated with the acceleration data associated with the movement of the probe, magnetic field data associated with magnetic fields located proximate the probe, voltage data associated with an external voltage source connected to the probe, and the distance and position data associated with a probe relative to a particular location or object. The software component may also be capable of calculating values of other characteristics associated with the collected experimental data such as velocity and displacement, an electric field proximate the probe, a current, resistance, and capacitance associated with an external source, a force, frequency, light polarization, sound intensity, pressure, and any other phenomena related to the interactive laboratory experiment using formulas and equations known in the art.

### BRIEF DESCRIPTION OF THE DRAWINGS

In the drawings,

FIG. 1 is a block diagram of a preferred embodiment of an interactive laboratory kit in accordance with the present invention;

FIG. 2 is a front perspective view of a preferred embodiment of hardware components of the interactive laboratory kit in accordance with the present invention;

FIG. 3 is a flow chart illustrating the operation of a software component in accordance with the present invention;

FIG. 4 is a side perspective view of a sensor probe for use with the interactive laboratory kit;

FIG. 5 is a schematic view of the sensor probe of FIG. 4 showing various components associated therewith;

FIG. 6 is a top perspective view showing wires connected to multiple voltage pins at the sensor probe in accordance with the present invention;

FIG. 7 is a side perspective view of a receiver module connected to a computer for use with the interactive laboratory kit in accordance with the present invention;

FIG. 8 is a schematic view of the receiver module of FIG. 7 showing various components associated therewith;

FIG. 9 is a diagram showing the data relationship between the various components of the interactive laboratory kit;

FIG. 10 is a front view of a command window shown on the student display for use with the interactive laboratory kit in accordance with the present invention;

FIG. 11a is a flowchart showing the operation of the receiver module when using the accelerometer sensor;

FIG. 11b is a flowchart showing the operation of the sensor probe when using the accelerometer sensor;

FIG. 12a is a flowchart showing the operation of the receiver module when using the Hall Effect Probe sensor;

FIG. 12b is a flowchart showing the operation of the sensor probe when using the Hall Effect Probe sensor;

FIG. 13a is a flowchart showing the operation of the receiver module when using the voltage sensor;

FIG. 13b is a flowchart showing the operation of the sensor probe when using the voltage sensor;

FIG. 14a is a flowchart showing the operation of the receiver module when using the ranging function;

FIG. 14b is a flowchart showing the operation of the sensor probe when using the ranging function;

FIG. 15 is a front view of a plot window showing a graphical output of processed data in accordance with the present invention;

FIG. 16 is a side view of a magnet proximate magnetic field sensors of the sensor probe for performing an experiment in accordance with the present invention;

FIG. 17 is a front view of a plot window showing a graphical output of processed data from the experiment shown in FIG. 16;

FIG. 18 is a front view of a command window shown on a display for use with the interactive laboratory kit in accordance with the present invention;

FIG. 19 is a front view of a plot window showing a graphical output of processed data on the display for use with the interactive laboratory kit;

FIG. 20 is a side perspective view of the sensor probe being used in an experiment in accordance with the present invention;

FIG. 21 is a front view of a plot window showing the graphical output of the processed data from the experiment in FIG. 20 in accordance with the present invention;

FIG. 22 is a side perspective view of the sensor probe being used in an experiment in accordance with the present invention;

FIG. 23 is a front view of a plot window showing a graphical out of the processed data from the experiment in FIG. 22 in accordance with the present invention;

FIG. 24 is a flowchart showing the operation of the software lesson application during a lesson module;

FIG. 25 is a sample screen output displayed by the software lesson application during a sample lesson highlighting the display of an information screen;

FIG. 26 is a sample screen output displayed by the software lesson application during a sample lesson highlighting the graphical output during data acquisition;

FIG. 27 is a sample screen output displayed by the software lesson application during a sample lesson highlighting an interactive question and answer session;

FIG. 28 is a sample screen output displayed by the software lesson application during a sample lesson highlighting the manual laboratory mode;

FIG. 29 is a perspective side view of the sensor probe collecting data associated with an induced magnetic field provided by a looped wire connected to a battery;

FIG. 30 is a top perspective view of a looped wire connected to voltage pins at the sensor probe for conducting an experiment in accordance with the present invention;

FIG. 31 is a top perspective view of a magnet placed above the looped wire of FIG. 20 for performing an experiment in accordance with the present invention; and

FIG. 32 is a front view of a plot window showing a graphical output of the processed data from the experiment in FIG. 31 in accordance with the present invention.

### DETAILED DESCRIPTION OF THE INVENTION

The invention disclosed herein is, of course, susceptible of embodiment in many forms. Shown in the drawings and described herein below in detail are the preferred embodiments of the invention. It is to be understood, however, that the present disclosure is an exemplification of the principles of the invention and does not limit the invention to the illustrated embodiments.

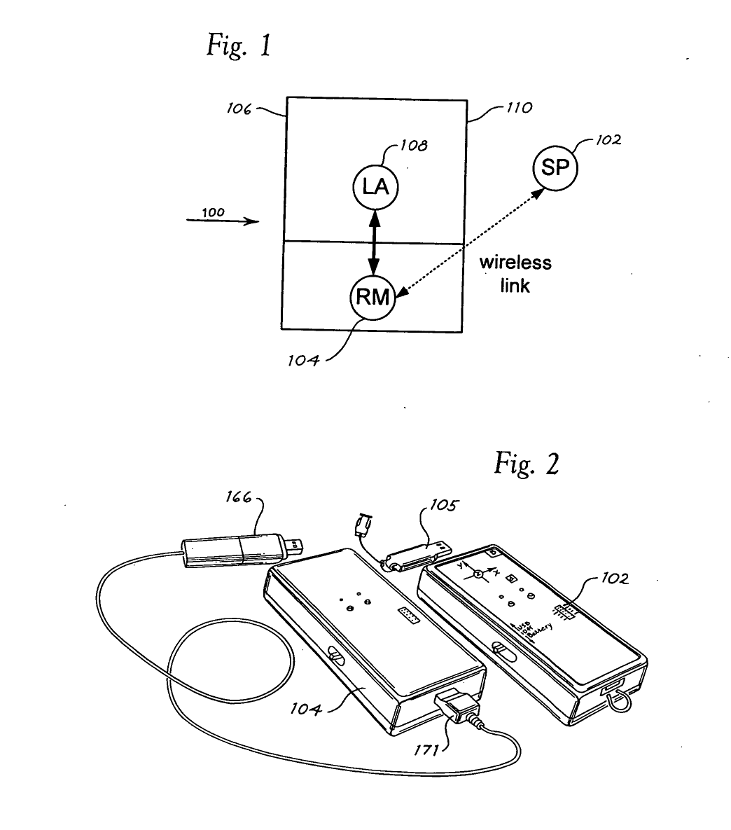

Referring to FIG. 1, an interactive laboratory kit 100 provides students with a self-paced and hands-on laboratory experience for performing scientific experiments at various locations, such as universities or colleges, high schools, dorm rooms or at home, or in any other educational environment. Accordingly, the interactive laboratory kit 100 may be used to replace or supplement traditional and expensive laboratory equipment and may be used to guide students through a laboratory experiment, evaluate performance, provide immediate feedback, and calculate and record laboratory grades.

In a preferred embodiment and referring to FIG. 2, interactive experiments may be performed using both hardware and software associated with the interactive laboratory kit 100. Hardware components may include a sensor probe 102, a receiver module 104, and a storage mechanism 105. The sensor probe 102 may be used to sense physical phenomena and collect data relating to the physical phenomena during the course of the experiment. The collected data is transmitted from the sensor probe 102 over a wireless link to the receiver module 104 and is in turn transferred from the receiver module 104 to a computer 106 for processing by a software component 108. In one example, the personal computer 106 may be any conventional computer having a display 110 or any device capable of supporting the required hardware and software. Those skilled in the art will appreciate that such devices include notebook computers, personal digital assistants, tablets, smart-phones, e-books, web-books or any other computer known in the art.

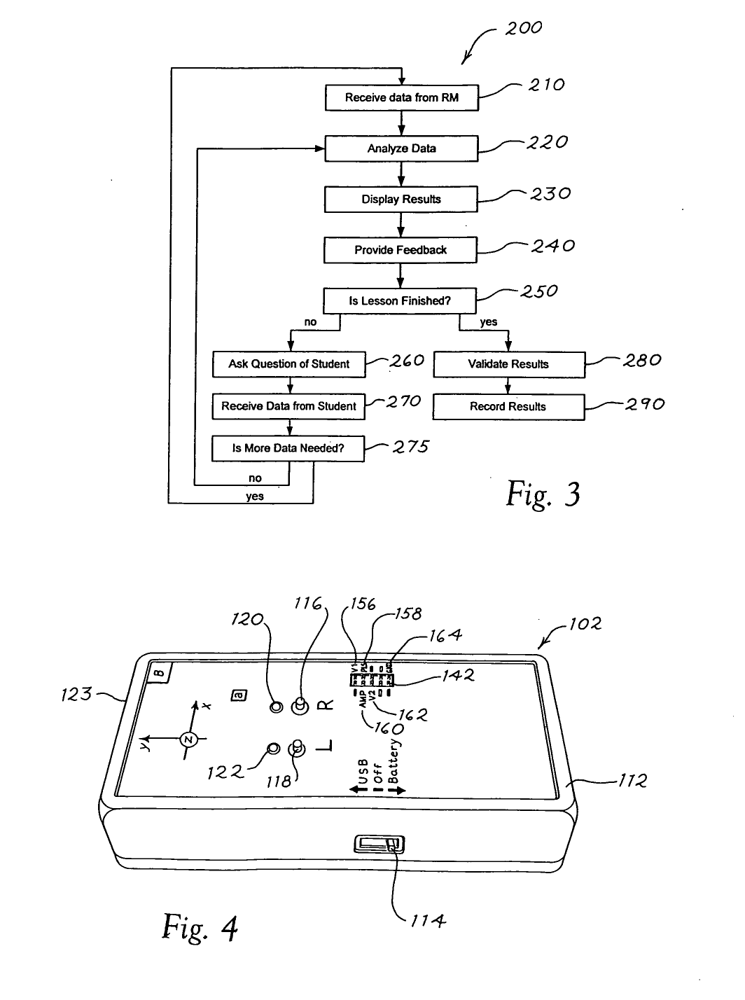

A general overview of the operation of the interactive laboratory kit 100 and the analysis of the data received at the computer 106 is detailed in FIG. 3. The computer 106 receives 210 the collected data from the receiver module 104 where it is processed 220 by the software component 108. The processed results are displayed 230 at the computer 106 in a format appropriate for the focus of the experiment. The results are compiled and informative feedback and other information, such as a student's performance, scores, or other performance indicators associated with the experiment is provided to the student.

If the lesson is finished 250, then the results are validated 280 and recorded 290 for future usage. If the lesson is not finished, then the software component 108 may provide the student another question 260. The student responds to the question 270 and the software component 108 will determine if more data needs to be collected 275. If no more data is needed, the software component will process the newly received data 220 and continue the process. If more data is needed, the student will collect additional data by performing additional experiments using the sensor probe 102. At the completion of the process, the software component 108 validates 280 and records 290 the results of the lesson in a data storage associated with the computer.

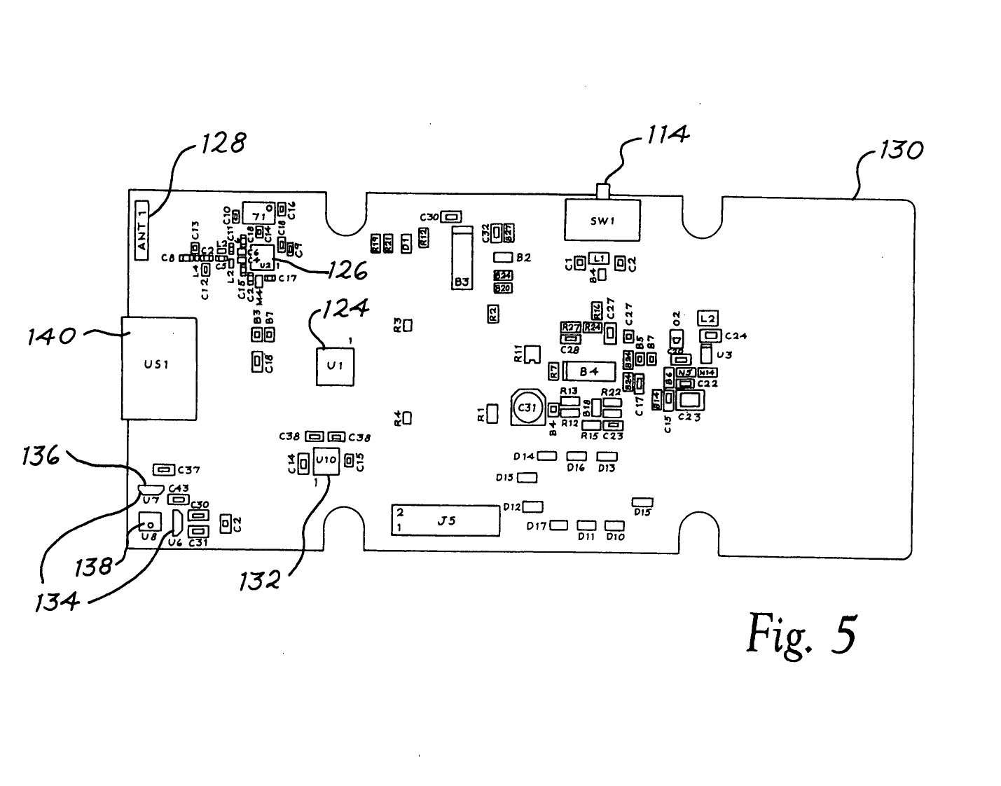

Referring to FIGS. 4 and 5, the student uses the sensor probe 102 to perform a variety of experiments. The lightweight and wireless nature of the sensor probe 102 provides a portable hardware unit allowing for convenient transport to various locations for conducting different experiments. In conducting the different experiments, the sensor probe 102 is equipped to sense and collect data relating to acceleration associated with movement of the probe, magnetic fields located proximate the probe, voltage associated with an external source connected to the probe, and a distance of the probe relative to an object. In other examples, additional sensors may be provided to sense and collect data associated with force, velocity, position, probe orientation, electric fields, current, resistance, capacitance, frequency, light intensity, light polarization, sound intensity, temperature, pressure, or any other physical phenomena.

The sensor probe 102 includes a generally rectangular housing 112 containing switches, buttons, sensors, and other components for controlling its operation. As shown in FIGS. 4 and 5, an actuator switch 114, an “R” button 116, an “L” button 118, and LEDs 120, 122 are disposed at the housing 112. The actuator switch 114 may be used to power the sensor probe 102 by sliding between an “OFF” position and a “Battery” position. While in the “Battery” position, the probe 102 is powered by a battery source located within a battery compartment at the housing 112. In one example, the sensor probe 102 may be powered by multiple AAA batteries, but it is contemplated that many styles of batteries and different configurations may be used. The sensor probe 102 also includes a USB connector 123 and may alternatively be connected to a computer and powered through a USB connection. In such an example, the sensor probe 102 may be powered by sliding the actuator switch 114 to the “USB” position. It is also appreciated that the sensor probe 102 may be powered by any other way known in the art. It is also appreciated that the USB connection can be replaced by other connection interfaces, including but not limited to, eSATA or IEEE 1394 FireWire.

The “R” and “L” buttons 116, 118 as well as the corresponding LEDs 120, 122 may be disposed adjacent the upper exterior surface of the housing 112 and may serve a variety of functions depending on the type of experiment being performed. In one example, the student may depress either the “R” or “L” button 116, 118 to wake a sensor probe 102 that is in a power conserve mode. During certain experiments, these buttons may also be used to activate a timer or input a particular value. The LEDs 120, 122 correspond to the “R” and “L” buttons 116, 118 respectively and may be adapted to illuminate upon depression of the corresponding button 116, 118 or in addition may be adapted to illuminate independently to indicate information concerning the interactive laboratory kit 100, such as the end of a portion of the experiment.

Still other uses for the “R” and “L” buttons 116, 118 respectively are contemplated for providing a way for the student to interact with the software component 108. It should also be recognized that the “R” and “L” buttons may be replaced with differently labeled buttons, or that there may be more or less than two buttons that serve the function of permitting a student to interact with the lesson software.

Internally, the sensor probe 102 also includes different components associated with operation of the probe 102. In particular, the housing 112 includes a controller 124, a transceiver 126 and antenna 128, as well as multiple sensors disposed on a printed circuit board 130. The transceiver 126 may also be configured as a separate transmitter unit and receiver unit.

The controller 124 may be a microcontroller such as a Texas Instruments MSP430F2274 Mixed Signal Microcontroller and used as a central device to control the operation and various functions associated with the sensor probe 102. The controller 124 interacts with the sensors by sampling and converting the collected experimental data from an analog to digital format. For example, an accelerometer 132 may be used to collect data associated with the acceleration of the sensor probe 102. The collected acceleration data may be analog data that is sampled by an analog-to-digital converter located at the controller 124. The controller 124 may then authorize the transceiver 126 to transmit the digital signal containing the collected data to the receiver module 104.

The transceiver 126 may be a Texas Instruments CC2500 2.4 GHz transceiver that may be used to transmit data to the receiver module 104. Using the transceiver, the sensor probe 102 is able to send the digital signal containing the collected data to the receiver module 104 at approximately 100 times per second over a wireless communication link. This allows the collected data to be analyzed and presented on the display in an approximately real-time format. It is also contemplated that the sensor probe 102 may support one-time measurements and transmissions, multiple periodic measurements are transmissions, and aperiodic measurements and transmissions to the receiver module 104.

In addition to sending data from the sensor probe 102 to the receiver module 104, the transceiver module 126 can also receive commands or data from the software component 108 through receiver module 104. For example, commands can be sent to the sensor probe 102 and received by the transceiver module 126 to configure or control components of sensor probe 102 such as the operation of particular sensors, sensor gain amplification, sensor sensitivity, or sampling frequency.

The plurality of sensors, disposed at the sensor probe 102, may be used for sensing phenomena and collecting experimental data associated with the sensed phenomena during an experiment. One of the plurality of sensors may be the accelerometer 132 capable of sensing and collecting data associated with acceleration of a moving sensor probe 102. In one example, the accelerometer 132 may be a single Analog Devices 3D accelerometer AADXL335BCPZ-RL and may be disposed on the printed circuit board 130 and operatively connected to the controller 124. Specifically, while the sensor probe 102 is moving, the accelerometer 132 collects acceleration data associated with the x, y, and z directions in correspondence with the movement of the probe 102 in those directions. The collected acceleration data may then be sampled by the connected controller 124 converting the analog collected data to a digital format allowing for transfer of a signal containing the acceleration data to the receiver module 104.

Magnetic field sensors, such as multiple Hall Effect sensors 134, may be located within the housing 112 and are capable of sensing and collecting data relating to a magnetic field proximate the probe 102. Referring to FIG. 4, the indicia marked “B” at the front corner of the housing 112 generally denotes the location of the internal Hall Effect sensors 134. Specifically, the Hall Effect sensors 134 may include through hole sensors 136 for measuring the x and y components of the magnetic field and a surface mount sensor 138 for measuring the z component of the magnetic field. In one example, the through hole sensors 136 are EQ-710L devices and the surface mount sensor unit 138 is an EQ-430L device both manufactured by Asahi Kasei that may be operatively connected to and sampled by the controller 124. Once sampled, the digital signal containing the collected magnetic field data may be transmitted to the receiver module 104.

Referring again to FIG. 5, an ultrasonic sensor 140 is used for sensing and collecting data associated with the distance between the sensor probe 102 and various other objects or locations. In one example, the ultrasonic sensor 140 may be a MaxSonar-UT Ultrasonic Transducer disposed at the printed circuit board 130 and connected to the controller 124.

In one example, the ultrasonic sensor 140 may be used to measure the distance between the sensor probe 102 and the receiver module 104. In this example, the receiver module 104 transmits a radio frequency signal to the sensor probe 102 while a controller 168 at the receiver module simultaneously initiates a timer. The radio frequency signal is received by the probe 102 and in response causes the ultrasonic sensor 140 to transmit an ultrasonic pulse toward the receiver module 104. The timer continues to toll until the ultrasonic pulse is received by the receiver module 104. Upon receipt, the timer stops and the time elapsed is used to calculate the total distance between the sensor probe 102 and the receiver module 104.

Another function of the ultrasonic sensor 140 is its ability to measure the distance between the sensor probe 102 and another object through transmission of an ultrasonic pulse. To measure the distance between the probe 102 and a particular object, the ultrasonic sensor 140 may transmit an ultrasonic pulse in the direction of a particular object. Transmission of the pulse causes the controller 124 at the sensor probe to simultaneously initiate a timer. Once the ultrasonic pulse reaches the object, it is reflected back toward the probe 102. The sensor probe 102 listens for the echo and upon receiving the reflected pulse, the controller instructs the timer to stop. Using the elapsed time data, the distance between the sensor probe 102 and the particular object may be calculated.

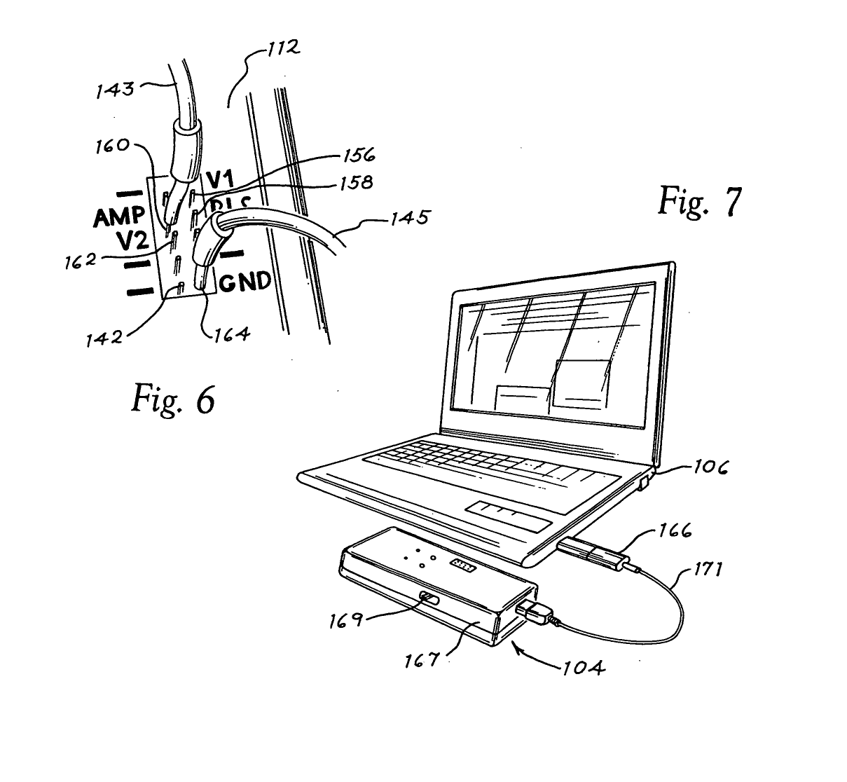

The sensor probe 102 may also include a plurality of voltage input pins 142 for sensing and collecting data associated with a voltage of an external source connected to the probe 102. As shown in FIGS. 4 and 6, the plurality of voltage pins 142 may be disposed proximate an upper surface of the housing 112 and include at a V1 pin 156, a PLS pin 158, an AMP pin 160, a V2 pin 162, and a GND pin 164. Each of the plurality of pins 142 may also be connected to the controller 124 allowing the collected voltage data to be sampled by an analog-to-digital converter in the controller 124. In alternate embodiments, the plurality of voltage pins 142 may be used as an expansion port to support additional devices such as an external sensor.

Specifically in one example, the external source may be connected to one of the plurality of input pins 142. As shown in the example in FIG. 6, wire portions 143 and 145 connected to the external source may be connected the AMP input pin 160 and the GND pin 164, respectively. The external source generates a voltage that is sensed at the input pins 142 and data relating to the external voltage is collected. The collected voltage data is sampled directly by analog-to-digital converter at the controller 124 allowing the produced digital signal containing the collected voltage data to be sent to the receiver module 104. This configuration may be appropriate for external sources providing signals ranging from 100 mV to 3V that are positive relative to ground. In another example, the external source may be connected to the voltage input pin 142 that is attached to a special high-gain amplifier through a positively biased AC coupled circuit whose output is then sampled by the controller 124. This configuration may be appropriate for external sources providing smaller signals ranging from approximately 0.01 mV to 10 mV and that are bipolar relative to the ground.

The sensor probe 102 may also be equipped with additional sensors or components for sensing and collecting data associated with different physical characteristics and phenomena during different experiments. For example, a piezoelectric sensor may also be included for directly sensing and collected data relating to the force or pressure associated with a particular experiment. Similar to above, these sensors may also be connected to the controller 124 thereby permitting sampling of the collected data where the digital signal containing the collected data is transmitted to the receiver module 104.

As previously discussed, the sensor probe 102 includes a USB connector 123. It is also appreciated that the USB connector 123 may be replaced by other known connection interfaces. In addition to supplying power, the USB connector 123 may be used to perform a number of functions. For example, the USB connector may be used as an interface for reprogramming the sensor probe 102. In other embodiments, the USB connector may be used to provide an expansion port for adding new sensor types.

The receiver module 104 is used for receiving a signal containing the collected experimental data from the sensor probe 102 and transferring the signal to the computer 106. Referring to FIGS. 7 and 8, the receiver module 104 includes a USB connector 166 for connecting to the computer 106 and thereby allowing the transfer of data through a USB cable 171.

The receiver module 104 also includes a housing 167 containing a variety of elements for receiving and transferring the experimental data collected by the sensor probe 102. Referring to FIG. 8, the receiver module 104 includes a controller 168 and a transceiver 180. The controller 168 may be a microcontroller, such as the Texas Instruments MSP430F2274 Mixed Signal Microcontroller, that is used as a central device for controlling the operation of the receiver module 104. The transceiver may be a Texas Instruments CC2500 2.4 GHz transceiver that may be used to receive the collected experimental data from the sensor probe 102. In another example, the receiver module 104 may include standard Wi-Fi® and Bluetooth® receivers. Those skilled in the art will appreciate that other wireless technology and other protocols may also be used. It will also be recognized that some of the functionality of the receiver module 104 may be subsumed by the personal computer 106 if the personal computer 106 includes a communication links to the sensor probe 102. For example, if the personal computer includes Wi-Fi® or Bluetooth® interfaces, a separate receiver module 104 may not be necessary as an intermediary between the software application 108 on the personal computer and the sensor probe 102. The function of the receiver module 104 may be performed by the software application 108. In another embodiment, the communication portion of the receiver module 104 may be handled by the Wi-Fi® or Bluetooth® interface on the personal computer 106. The personal computer 106 may thus communicate directly with sensor probe 102.

The receiver module 104 may also include an actuator switch 169 and a first and second button 170, 172 and adjacent and corresponding LEDs 174, 176. The receiver module 104 may be powered by sliding the actuator switch 169 from an “OFF” position to an “ON” position. Each button 170, 172 may also have different functions depending on the type of experiment being performed. Similarly, each LED 174, 176 may illuminate upon depression of the corresponding button 170, 172 or they may illuminate independently to indicate some type of information concerning the interactive laboratory kit 100.

The storage mechanism 105, shown in FIG. 2, may be used to store electronic files or content used in implementing the interactive laboratory experience, such as the software component 108. The storage mechanism 105 may be any type of data storage device such as a USB flash drive, a diskette, a compact disk, or an external hard drive. A student is therefore able to connect or otherwise insert the storage mechanism 105 into the personal computer 106 for accessing the contents stored thereon. Once connected, a student may access the contents of the storage mechanism 105 using the personal computer 106 before initiating the experiment. In another example, the storage mechanism 105 may be an internal hard drive or any other type of storage unit associated with the personal computer 106. In still another example, the storage mechanism may be a type of online storage accessible via the Internet or by entering a password.

The software component 108 includes software adapted for implementing a lesson application program for use on the personal computer 106 and executing multiple sets of instructions for processing the collected data and calculating and displaying magnitudes and values of the physical phenomena associated with the collected data.

The lesson application program 108 may be adapted for execution on a personal computer 106 that is local to the student. With reference to FIG. 9, the lesson application serves as an interface between the student and the interactive laboratory kit 100. The lesson application 108 is in communication with a lesson database 109. The lesson database 109 may be hosted locally at the same location as the student, or it may be located on a remote server accessible through the Internet or other network connection. The lesson application 108 also displays information to the student, such as on a computer monitor, providing instructions to the student and providing the student with assessment prompts to assess understanding of the lesson. Through the personal computer 106, the student can also input data to the lesson application 108. The lesson application 108 is also in communication, such as by USB cable or through wireless communication, with the base or receiver module 104 to provide control data and receive sensor data and results from the receiver module 104. The base 104 also serves as an intermediary for control commands from the lesson application 108 to the sensor probe 102, as well as for sensor data from sensor probe 102 to the lesson application 108.

Lesson modules may be stored in the lesson database 109 and retrieved by the lesson application 108 for local use by a student. As the student progresses through the lesson module, the performance of the student on various aspects of the lesson are evaluated by the lesson application 108 and transferred to the lesson database 109. Data obtained from the sensor probe 102 and receiver module 104 may also be transferred through the lesson application to the lesson database, where the data can be further analyzed as needed.

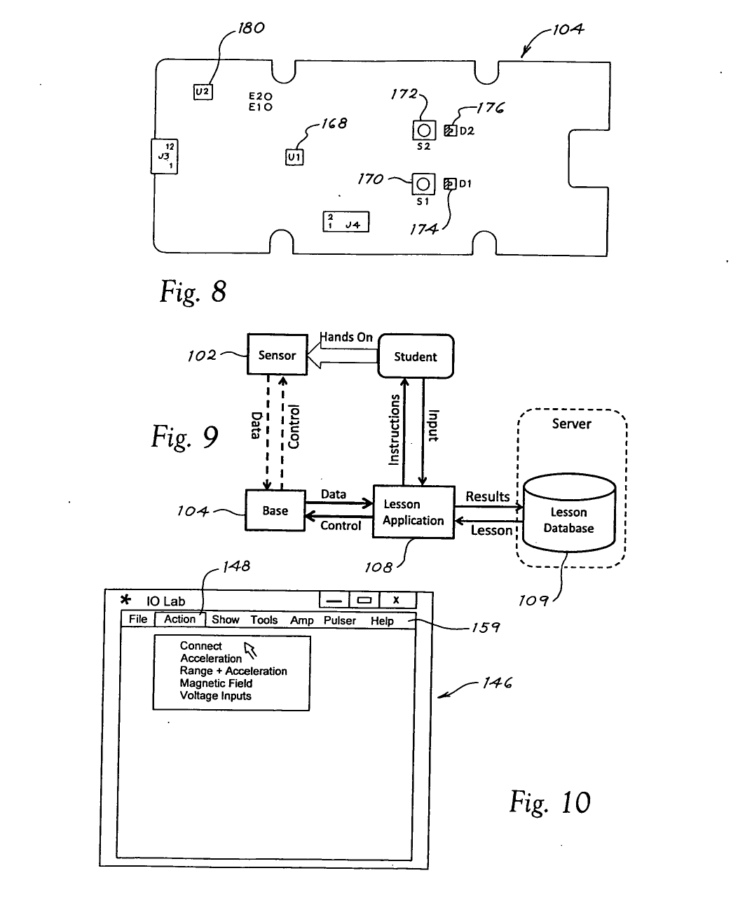

In particular, the lesson application program may provide an interactive student interface for accessing and controlling various experiments and may provide guidance and instruction during the course of the interactive experiment. Referring to FIG. 10, the student may begin an experiment by initiating software to execute the lesson application program. This may be accomplished by clicking an icon associated with the lesson application program at the computer 106 using a mouse, a keyboard, a trackball, or any other associated peripheral device. Upon initiation of the lesson application program, a command window 146 having a pull down toolbar 159 and other pushbuttons for selecting different settings, preferences, or other options associated with the interactive laboratory kit 100 will appear. The student may begin the experiment setup by selecting the “Connect” option at the Action pull-down menu 148 thereby opening the wireless communication link between the sensor probe 102 and the receiver module 104. In the preferred embodiment, this wireless communication link may be implemented using a wireless radio frequency technology and protocol and may include standard WiFi® and Bluetooth® technology. Those skilled in the art will appreciate that other wireless technology and other protocols are also appropriate. Once connected, the command window 146 will display and continuously update the status of the receiver module 104 or base unit base unit and the sensor probe 102.

As described above, the sensor probe 102 may be powered to an ON position by sliding the actuator switch 114 to the “Battery” or “USB” position. To conserve battery power while not in use, the sensor probe will enter a sleep mode after a period of inactivity. When it is time for the experiment, the student may wake the sensor probe 102 by pressing one of the “R” or the “L” buttons 116, 118.

Once the sensor probe 102 is awake, the student may select an experiment at the Action pull-down menu 148 from the list of displayed experiments. In this example, and referring to FIG. 10, the student has the option of choosing the “Acceleration,” “Range+Acceleration,” the “Magnetic Field,” or the “Voltage Inputs” experiments. Upon selection of one of these experiments, the sensors on the sensor probe 102 associated with the selected experiment will be actuated and the interactive experiment may commence. As discussed above, it is conceivable that additional experiments may also be included on the Action pull-down menu 148.

The lesson application program may also guide the student through the experiment by providing instructional materials and evaluating the student's performance. For example, the lesson application program may display instructions for performing the experiment or onscreen graphics displaying preferences from the selected experiment. This allows the student to read through the instructions on the computer display 110 while performing the experiment. In addition, the lesson application program may display questions or quizzes regarding the particular experiment. The student is able to respond and have the answers quickly evaluated and graded by the lesson application program. It is of course conceivable, in another example, that traditional hard copy instructions and questions may be provided to the student for use during the interactive experiment.

The software component 108 also includes software for controlling the functionality of the receiver module 104 and the sensor probe 102. The sensor probe 102 and the receiver module 104 default to idle states in which they are listening for signal traffic. In one embodiment, the sensor probe 102 can receive information via radio frequency signals from the receiver module 104. The receiver module 104 can receive signal traffic from the sensor probe 102 or from the software component 108.

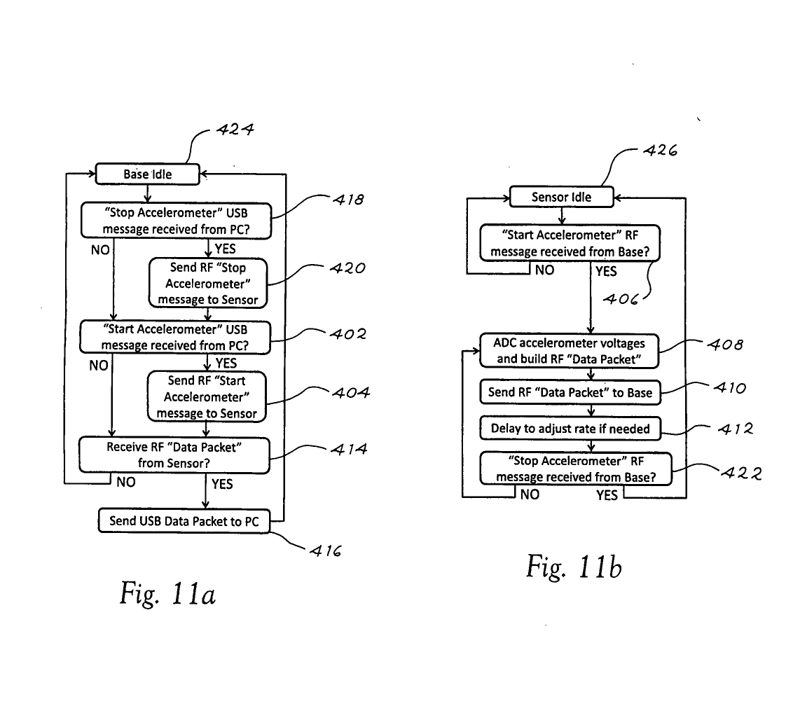

FIGS. 11a and 11b illustrate functional flowcharts for operating the sensor probe 102 and the receiver module 104 in an accelerometer experiment. The software component 108 sends a “Start Accelerometer” command message to the receiver module 104. Upon receiving this command 402, the receiver module 104 sends a “Start Accelerometer” command message to the sensor probe 102 to begin data acquisition from the accelerometer sensor 132, step 404.

Once activated 406, the accelerometer sensor samples and digitizes the voltages on the accelerometer chip outputs corresponding to the acceleration in the x, y, and z axes using the analog to digital converter built into the microcontroller 124. A data packet containing information is also assembled 408. The data packet is sent, step 410, by radio frequency communication to the receiver module or base 104. An optional delay 412 can be incorporated to adjust the rate at which sensor probe 102 transmits sensor information to the base 104. In one embodiment, the delay is configured so that approximately 100 data packets per second are sent from the sensor probe 102 to the base 104. As data packets are received, step 414, from the sensor probe 102, the base or receiver module 104 communicates the data packet to the software component 108 on the personal computer 106, step 416.

A “Stop Accelerometer” command, step 418, can be initiated by the software component 108 through a timed termination or as the result of input from the user. The software component 108 communicates a “Stop Accelerometer” command via USB connection to the receiver module 104. The receiver module 104 then communicates the command to the sensor probe 102, step 420. Once a “Stop Accelerometer” command from the receiver module 104, the previously described data acquisition loop is terminated and the sensor probe 102 returns to the default idle state, step 424.

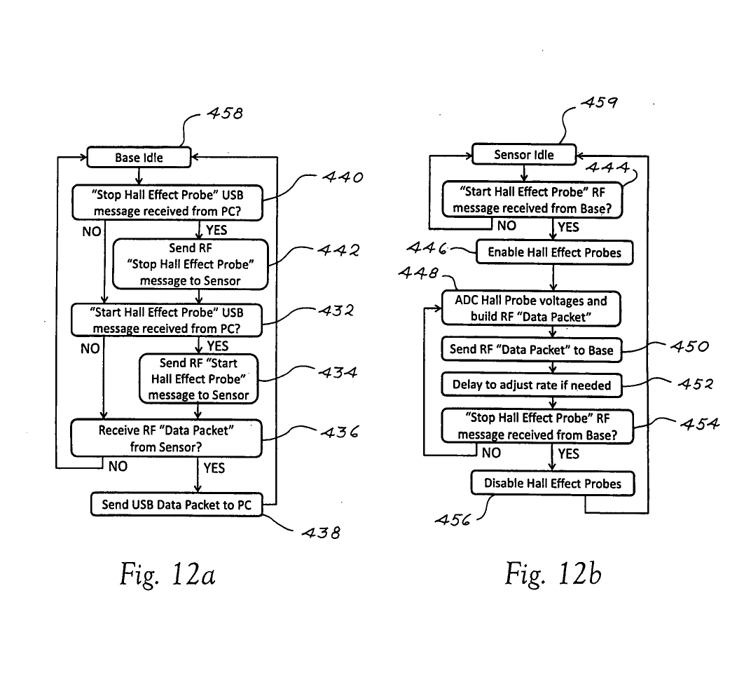

FIGS. 12a and 12b illustrate functional flowcharts for the receiver module and the sensor probe while operating the Hall Effect probe sensors. As with the accelerometer, the Hall effect probe sensors are controlled by start and stop commands originating from the software component 108. Upon receipt of a start message, step 432, from the software application 108, the receiver module 104 communicates a message 434 to the sensor probe 102 to start the Hall Effect probe. In response 444, the sensor probe 102 enables 446 the Hall Effect probe 134. Similar to the process previously described in connection with the accelerometer sensor, the analog to digital converter samples voltages in step 448 from the Hall Effect probe sensors corresponding to the magnetic field along the x, y, and z axes. Data packets containing the sensor information are assembled and communicated in step 450 to the receiver module or base 104, which in turn is transmitted to the software component 108 on the personal computer 106. This data acquisition loop continues until a stop command is issued from the software component 108, for example as a result of user action or after a programmed duration. The stop command is received, step 440, by the receiver module 104 and communicated, step 442, from the sensor probe 102. Upon receipt of the stop command, the sensor probe 102 disables, step 456, the Hall Effect probes 134 and returns to idle.

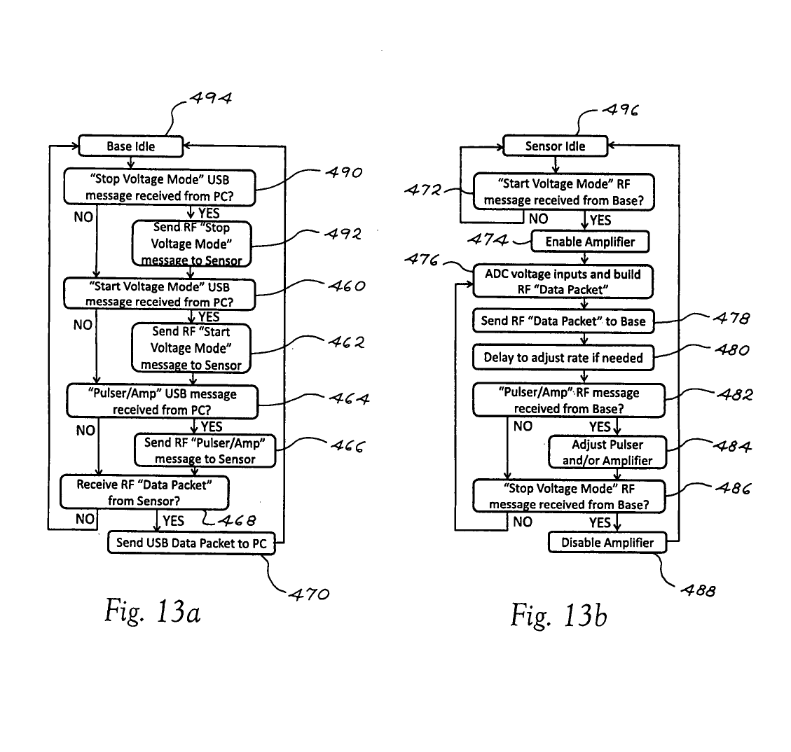

FIGS. 13a and 13b illustrate functional flowcharts for the receiver module and the sensor probe during operation of the voltage sensor. Upon receipt of a “Start Voltage Mode” command, step 460, from the software application 108, the receiver module 104 communicates a “Start Voltage Mode” message to the sensor probe 102, step 462. When the message is received, step 472, the sensor probe 102 enables a high-gain amplifier prior to entering the data acquisition loop, step 474. Once in the data acquisition loop, the externally applied voltages from the voltage input pins V1 156 and V2 162 as well as an amplified version of the externally applied voltage on the AMP input pin are sampled, step 476. The sampled data is assembled in a packet and transmitted to the receiver module 104, step 478. An optional delay can be incorporated to adjust the rate at which sensor probe 102 transmits sensor information to the base or receiver module 104, step 480. The data acquisition loop continues until a stop command is issued, step 490, from the software component 108 through the receiver module 104. Upon receipt of the stop command, the sensor probe 102 disables the amplifier, step 488, and returns to an idle state, step 496.

The software application 108 can be configured to send commands to adjust the response of voltage input pins 142 on the sensor probe 102. Upon receipt of a command message, step 464, the receiver module 104 can pass the command on to the sensor probe 102, step 466. Upon receipt of the command message, step 482, shown as “Pulser/Amp” message on FIG. 13, the sensor probe 102 decodes the message and performs the commanded action to adjust the sensor response, step 484. Such actions may include as an example, but are not limited to, changing the gain of the amplifier, setting a fixed voltage on the PLS output pin 158, setting the voltage on the PLS output pin 158 to toggle at a pre-determined frequency, doubling the frequency of the toggling voltage on the PLS output pin 158, or halving the frequency of the toggling voltage on the PLS output pin 158.

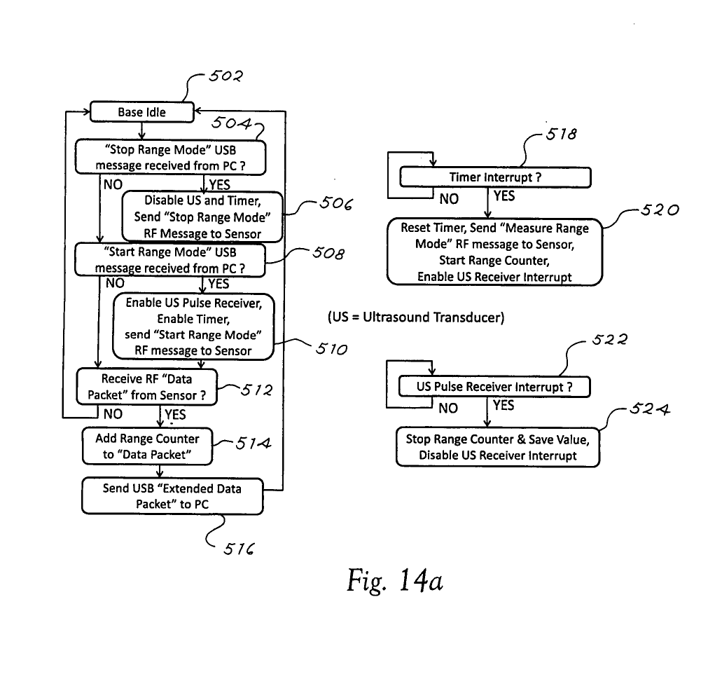

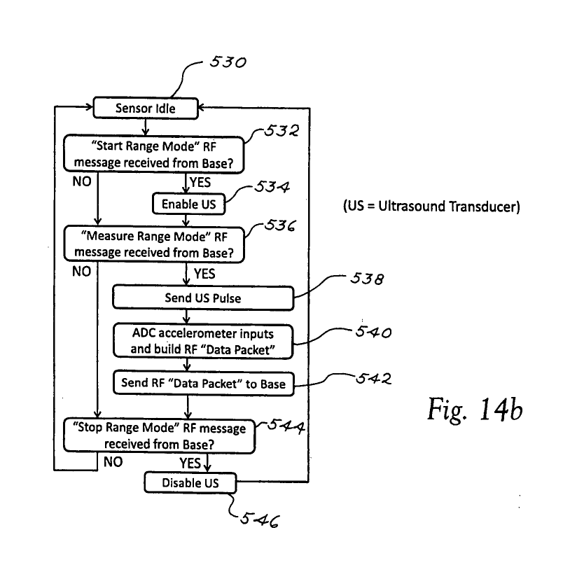

FIGS. 14a and 14b illustrate flowcharts for illustrating the functionality of using the receiver module 104 and sensor probe 102 in a ranging mode using the ultrasound transducer 140. Upon receipt of a “Start Range Mode” command from the software component 108, step 408, the receiver module 104 enables a ultrasonic receiver for receiving signals from an ultrasonic transducer, starts a timer which controls a timing interrupt, and sends a “Start Range Mode” message to the sensor probe 102, step 410. In some embodiments, the ultrasonic receiver may be, but is not necessarily, a physically separate component from the transceiver 180 within the receiver module 104. Each time the timing interrupt is triggered, step 418, the receiver module 104 resets the timer, sends a “Measure Range Mode” command to the sensor probe 102, starts a high speed Range Counter in the microcontroller 168, and enables an interrupt controlled by the ultrasonic receiver, step 520. In a contemplated embodiment, the timer interrupt is triggered at a predetermined rate of 80 Hz.

Upon receiving a “Start Range Mode” command from the receiver module 104, step 532, the sensor probe 102 responds by enabling the ultrasonic transmitter 140, step 534. When the sensor probe 102 receives a “Measure Range Mode” command, step 536, triggered by the timing interrupt, from the receiver module 104, the sensor probe 102 transmits an ultrasonic sound pulse from the ultrasonic transmitter, step 538. An analog to digital converter samples and digitizes the voltages on the accelerometer chip outputs corresponding to the x, y, and z axes, step 540. This information is assembled into a data packet and sent from the sensor probe 102 to the receiver module 104, step 542. The sensor probe 102 returns to idle to await the next “Start Range Mode” command, step 530.

When the ultrasonic pulse is received by the receiver module 104, the ultrasonic receiver generates an interrupt, step 522. This pulse receiver interrupt signal causes the receiver module 104 to stop the Range Counter, record its value and to disable further ultrasonic receiver interrupts, step 524. When the data packet transmitted by the sensor probe 102 is received by the receiver module 104, step 512, the Range Counter value is sent along with the data packet to the software application 108. The Range Counter value may be appended or encoded into the data packet, step 514, before transmission to the software application 108, step 516.

The cycle described above continues until the software component 108 sends a “Stop Range Mode” command to the receiver module 104, step 524. Upon receipt of the “Stop Range Mode” command, the receiver module 104 disables the ultrasonic receiver and timer, step 506. The receiver module 104 also transmits a “Stop Range Mode” command to the sensor probe 102. Upon receipt of the command, step 544, the sensor probe 102 disables the ultrasonic transmitter, step 546, and returns to an idle state, step 530.

One of skill in the art will appreciate that other types of sensors and program configurations can be adapted to suit the needs of the user. It should also be appreciated that while the descriptions above describe obtaining one type of sensor data at a time for clarity, the sensor probe 102, receiver module 104, and the software component 108 may in some embodiments acquire information from multiple sensors at the same time.

The software component 108 also includes software adapted for executing multiple sets of instructions on the computer 106 that are capable of processing the collected experimental data, calculating magnitudes and values associated with the collected experimental data, and presenting the processed data and calculated magnitudes and values at the computer display 110. Each set of instructions may be correlated with a particular interactive experiment and selected in response to actuation or selection of the corresponding interactive experiment for selectively processing the signals received from the receiver module 104. For example, if a student selects the “Acceleration” experiment at the command window 146, a set of instructions pertaining to the processing, calculation, and presentation of data collected from the accelerometer 132 may be selected. Once selected, the particular set of instructions associated with the interactive experiment may be executed by the computer 106 to process the collected experimental data.

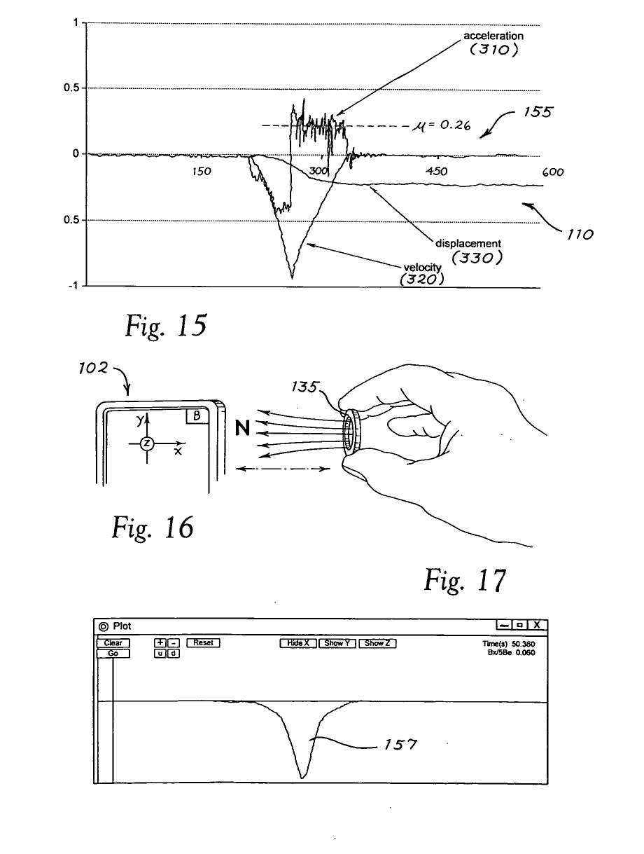

The software execution of a particular set of instructions relating to the processing, calculation, and presentation of data collected from the accelerometer 132 is shown by way of example in FIG. 15. The experiment shown in FIG. 15, known as the “box experiment,” allows the student to review Newton's 2^{nd} Law of Motion. In this experiment, the student is asked to calculate the coefficient of friction μ of a particular surface using the formula μ=a/g. To perform the “box experiment,” the student places the sensor probe 102 in the box and pushes it, causing both the box and the sensor probe 102 to slide across the surface before eventually coming to a stop. As the box and sensor probe 102 slide, the accelerometer 132 senses the probe 102 is moving and collects acceleration data in the x, y, and z directions relating to the movement. The acceleration data is sampled by the controller 124 and a signal containing the collected acceleration data is transmitted to the computer 106 via the receiver module 104.

The software executes a set of instructions associated with the acceleration experiment for processing the collected acceleration data. In one example, the set of instructions is adapted for calculating the magnitude of the acceleration of the sensor probe 102 in the various directions at particular times during the experiment from the collected acceleration data.

In addition, the software is also capable of executing sets of instructions calculating the value of other characteristics associated with the collected acceleration data such as the velocity or the displacement of the sensor probe 102, or any other related characteristic at different times during the experiment using well known formulas and equations.

As shown in FIG. 15, the display 110 shows the graphical plot representation 155 of the acceleration, velocity, and displacement of the sensor probe within the box in the “box experiment.” Specifically, the line labeled “acceleration” 310 shows the box's horizontal acceleration in units of g as measured in real-time by the sensor probe 102 and calculated by the software. Similarly, the line labeled “velocity” 320 shows the box's horizontal velocity and the line labeled “displacement” 330 shows the box's horizontal displacement from its original position. The graph shows that the box was given its initial shove just past the 200 mark on the horizontal axis as indicated by the downward bump of acceleration line 310. The graph also shows the box coasting to a stop between the 250 mark and 350 mark on the horizontal axis. The student may therefore analyze this data to obtain the coefficient of friction μ by fitting the dashed line to the data points of the acceleration line 310. As a follow up exercise, the lesson application program may also guide the student to use the acceleration data to calculate and display the velocity and displacement of the box as a function of time.

In some experiments, the probe 102 may remain relatively stationary while the student uses the probe's sensors to perform the experiment. For example, a student may calculate a magnetic field associated with a charged wire or magnet by positioning the charged wire or magnet within range of one of the magnetic field sensors located on the sensor probe 102.

Data collected by the Hall Effect sensors 134 and processed by the software component 108 is shown in FIGS. 16 and 17. Referring to FIG. 16, a student may test the Hall Effect sensors 134 by moving a magnet 135 toward the housing 112 of the sensor probe. If the pole facing the sensor probe 102 is polarized as North, the internal sensors 134 will sense the polarity and collect data associated with the detected polarity. A signal containing the collected magnetic field data is transmitted to the receiver module 104 and then sent the computer 106 where it is analyzed by the software component 108 resulting in negative trace 157 indicating the North polarity being displayed as shown in FIG. 17. If the pole facing the sensor is polarized as South, the internal Hall Effect sensors 134 will sense and collect the magnetic field data relating to the South polarity and such data will be analyzed by the software component 108 resulting in a positive trace indicating a South polarity being displayed.

The software component 108 also includes software capable of executing sets of instructions for presenting the calculated magnitudes and values associated with the collected data, substantially in real-time, on a physical display such as the computer display 110. Since the sensor probe 102 is adapted to continuously collect data and may transfer the data to the receiver module 104 at approximately 100 times per second, the calculated results are generated and presented, substantially in real-time, in a format that is appropriate for the focus of the experiment.

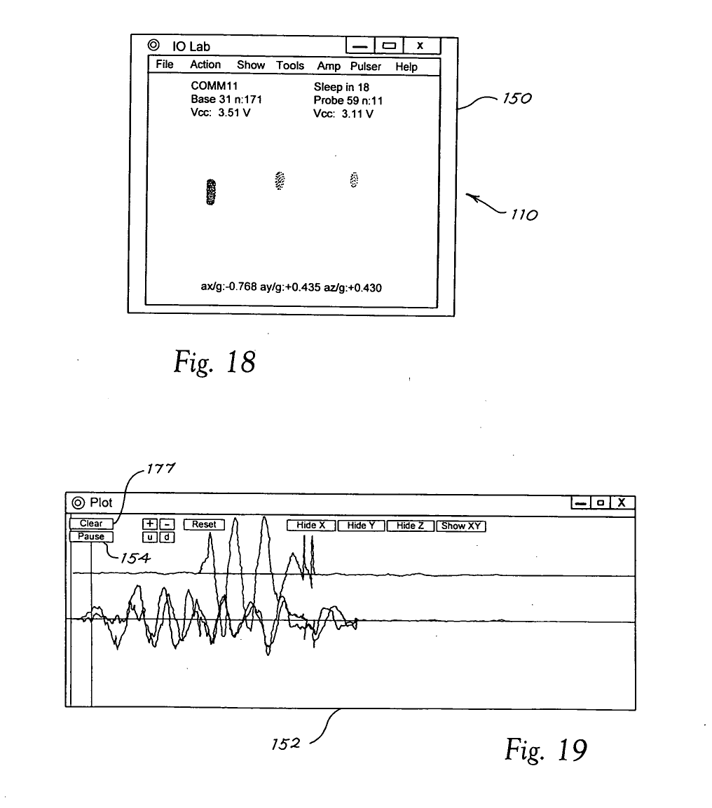

In one example and referring to FIG. 18, the computer display 110 presents a command window 150 displaying three colored vertical lines that represent the analyzed acceleration data. The vertical lines shown in FIG. 18 represent the x, y, and z components of the acceleration data associated with the movements of the sensor probe 102 taken at a particular time. The command window 150 also shows the corresponding numeric values indicating the magnitude of the acceleration below each vertical line. In this example, the acceleration in the x direction was −0.768 g m/s² (where g=9.81 m/s²), the acceleration in the y direction was 0.435 g m/s² and the acceleration in the z direction was 0.430 g m/s².

In another example, as shown in FIG. 19, the display 110 presents a plot window 152 showing the x, y, and z acceleration components as a function of time along a horizontal axis 153. While the experiment is ongoing, the values for the x, y, and z components and the corresponding plot trace will continuously update, substantially in real-time. Once the experiment is complete, the student may view the different acceleration values associated with the movement of the sensor probe 102 at any time during the experiment. Using a mouse, keyboard, or other associated peripheral device, the student may choose to hide or show the “x,” “y,” “z,” “V,” and “XY” components on the plot window 152 by selecting the corresponding push-button on the display screen.

The student may select the pause push-button 154 on the display screen to pause the plot and stop the continued presentation of the collected acceleration data. This allows the student to examine the plot values on the curve at any place on the horizontal time axis. By clicking the left mouse button, a thin vertical black line is drawn through the point where the mouse is located, and a small black dot is drawn where the line intersects each of the traces on the plot. As shown in FIG. 19, the value of the data at these points at the specific time is shown in the upper right corner of the plot window. In this example, at the time 7.948 seconds of the experiment, the acceleration in the x direction is 0.345 g, the acceleration in the y direction is −0.011 g, and the acceleration in the z direction is 0.998 g. The student may also press the “Clear” push-button 177 to clear the previous results and begin displaying newly acquired results.

Depending on the type of the experiment, the student may be instructed, either by the lesson application program or hard copy instructions, to use the displayed acceleration, velocity, and position data to make different computations. In the “box experiment,” discussed above, the student may be asked to compute the coefficient of friction for the surface using the proper formulas and equations. The student may enter the computed value for the coefficient of friction using the personal computer 106 and the lesson application program compiles the results and provides informative feedback information to the student regarding the student's performance and scores as well as other information relating to the performed experiment. In one example, the feedback may include both audio and visual feedback or may include performance assessment directed toward the course instructor. In one example, the screen may display, “well done, that only took you 7 minutes to accomplish” or other messages relating to informative feedback for the student.

The lesson application program 108 may also be configured to correspond to a specific course textbook and instruct and implement interactive experiments based on the guidelines and teachings of the chapters and sections of the book. This would enable a fluid integration between the interactive laboratory kit 100 and the lecture component of a particular course. The lesson application program may also be adapted to interact with different course management interfaces for recording grades and keeping track of student performance. In one example, the lesson application program 108 may interact with course management Internet websites such as Blackboard or Angel thereby facilitating the storage and accessing of graded laboratory assignments.

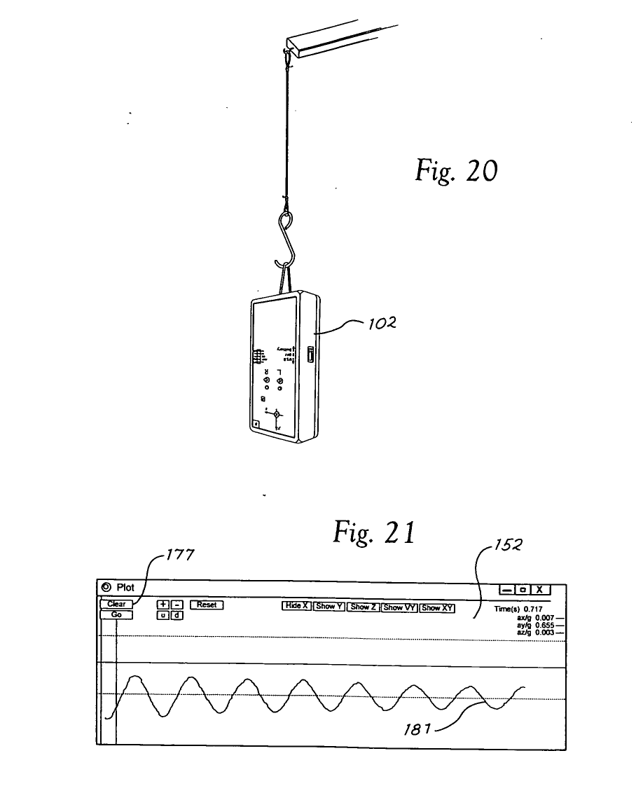

As indicated above, the interactive laboratory kit 100 may be used to perform numerous types of interactive experiments. By way of example, a student may perform an interactive experiment relating to the movement and oscillations associated with a simple pendulum. As shown in FIG. 20, the experimental setup includes the sensor probe 102 hanging upside down and suspended from a paper clip by a string. To perform the experiment, the student will use the acceleration data to calculate other characteristics within the experiment environment. The student will, therefore, select the “Acceleration” experiment at the interactive interface thereby initiating the accelerometer 132. When setup is complete, the student may conduct the experiment by pushing the sensor probe 102 to one side causing the probe 102 to act as a pendulum and oscillate back and forth.

The accelerometer 132 collects data relating to the sensor probe's pendulum-like movements at each time during the experiment and transmits the data to the personal computer 106 via the receiver 104. The collected data is processed by the software component 108 and resulting acceleration magnitudes are calculated from the collected acceleration data. The software component 108 presents the resulting acceleration magnitudes on a display 110 as illustrated by the oscillation trace 181 shown in plot window 152 of FIG. 21. The oscillation trace 181 shows the time and the acceleration of the probe 102 at each position during the oscillation pattern. The student may use the computer 106 to select a portion of the oscillation trace 181 to view the acceleration data of the probe at a particular time during the experiment. As shown in this example, the student can see that at a time of 0.717 seconds during the experiment, the acceleration in the y direction is −0.655 g.

Depending on the particular experiment, the lesson application program may provide instructions for the student to calculate a variety of information associated with the oscillation of the sensor probe 102 pendulum. In one example, the student may visually measure the period of the oscillation by observing the computer display 110. The student may use the measured period of oscillation to calculate the frequency and the angular frequency ω of the sensor module 102 using the well known frequency formulas f=1/T and ω=2πf, where T is the period. The student may also take other measurements and make other calculations associated with the experiment. For example, the student may also be asked to use the angular frequency ω value to calculate the length of the pendulum using the formula ω²=g/L.

The interactive pendulum experiment may also instruct the student to calculate the period of oscillation of the pendulum having large amplitudes. In this portion of the experiment, the student is instructed to start the pendulum with a larger angle than before, i.e., 45°. To begin the experiment, the student selects the “Clear” button 177 to erase the previous data and begin a fresh plot for displaying data associated with this portion of the experiment. As the oscillation trace is presented for this portion of the experiment, the student will once again be able to calculate the period of the oscillation of the pendulum and compare it to the earlier obtained and calculated results.

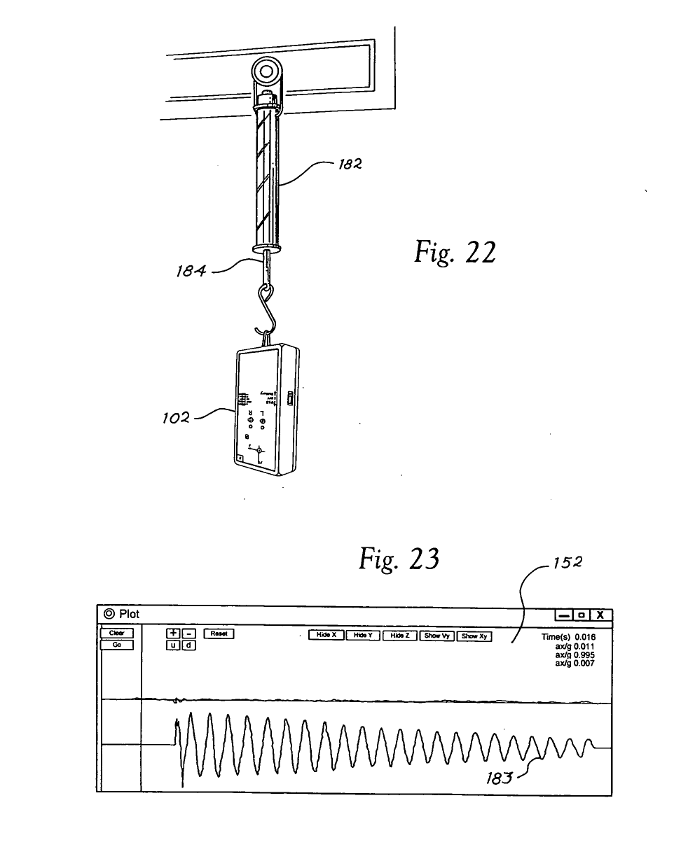

The interactive laboratory kit 100 may also be used to perform an interactive experiment pertaining to simple harmonic motion as shown in FIGS. 22 and 23. Referring to FIG. 22, the setup includes a spring scale 182 hanging from a platform and the sensor probe 102 hanging from a hook 184 at the bottom of the spring scale 182. Similar to above, the student will use acceleration values to make calculations pertaining to the experiment. The student will, therefore, select the “Acceleration” experiment at the interactive interface causing initiation of the accelerometer 132. Once the setup is complete, the student may begin the interactive experiment by pushing the sensor probe 102 in a particular direction causing it to oscillate. While oscillating, the accelerometer 132 collects acceleration data relating to the movement of the probe 102.

The acceleration data is processed by the software component 108 and resulting acceleration magnitudes for given times during the experiment are calculated from the collected acceleration data. The software component 108 presents resulting acceleration magnitudes on a display as illustrated by the oscillation trace 183 shown in plot window 152 including the acceleration of the pendulum at different times during the experiment as shown in FIG. 23. In this example, at time 0.8116 seconds, the acceleration in the x direction is 0.011 g, in the y direction is −0.995 g, and in the z direction is −0.007 g.

The instructions of the simple harmonic motion experiment may ask the student to measure and calculate a variety of characteristics associated with the experiment. For example, the student may visually measure the period of oscillation of the probe and use the measurement to calculate the frequency and the angular frequency using the methods and formulas discussed above. The student may use other known formulas to calculate other characteristics, such as using ω²=k/m and the known spring constant k to calculate the mass of the probe.

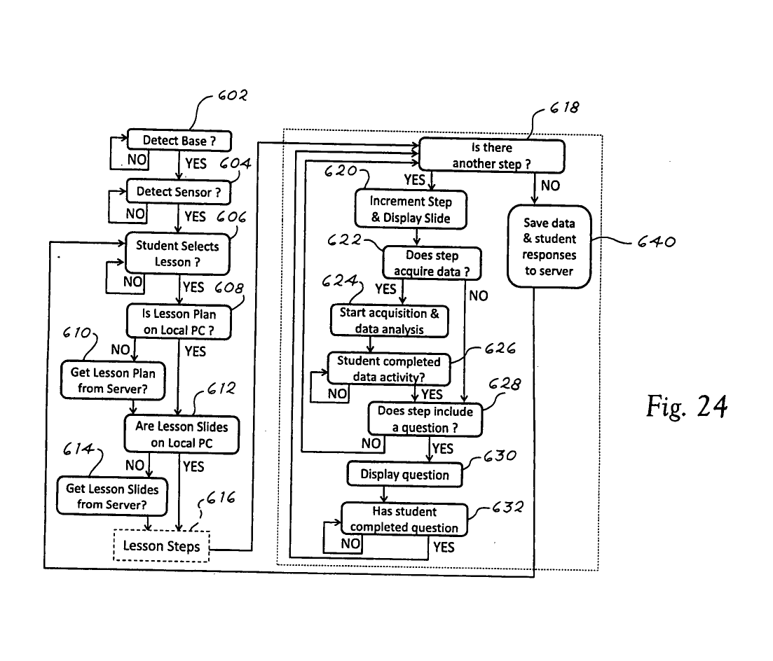

The software component or lesson application 108 running on personal computer 106 performs a number of functions that will now be described with reference to FIG. 24. The student starts the lesson application program 108 and is instructed by the lesson application to turn on the receiver module 104. When the lesson application detects that the receiver module 104 has been turned on, step 602, and that the sensor probe has been turned on, step 604, the lesson application displays a confirmation through the personal computer 106 confirming the status of the receiver module 104 and the sensor probe 102 to the student. The lesson application then sends a query to the lesson database and obtains a list of available experiment lesson modules to the lesson application. The lesson application generates a display of available lesson modules to the student. The student then chooses the desired experimental lesson to be executed, step 606.

Upon selection of a lesson module by the student, the lesson application then evaluates if the lesson module is available locally, step 608. If it is not, the lesson application communicates with the lesson database and obtains detailed information about the lesson module, steps 610 and 614. Information about the lesson module may including all text and graphics used in the module, any assessment questions that may be used to probe a student's understanding during the lesson module, and specific instructions for the lesson application 108 on how to interpret and respond to or process data obtained from the receiver module 104 and sensor probe 102 during the lesson.

The lesson application 108 presents each step of the lesson module to the student, step 616, and proceeds to the next step only after a student has fulfilled all of the requirements for that step. The lesson application 108 may check for any combination of a number of requirements to be met, such as receiving a correct answer from the student to an assessment question, the performance of a specified action on the personal computer 106 such as the input of a carriage return to continue the lesson, detecting the receipt of information from the receiver module 104 corresponding to the student pressing an input button on the sensor probe 102, or receiving measurements made by the sensor probe 102 within a set of values specified by the lesson module.

During each step of the lesson module, the lesson application 108 receives and stores data acquired by sensor probe 102 via receiver module 104. Depending on the lesson module, the data can be sensor data from an accelerometer, magnetic field measurements, voltage measurements, range measurements, force measurements, activation of buttons on the sensor probe 102, movement of the sensor probe 102, or other data. The lesson application 108 also records any action input received through the personal computer 106 from the student, such as answers to multiple choice or free response essay assessment questions displayed by the lesson application 108.

During the progress of the lesson, the lesson application 108 progresses through each step in the lesson module. If there is a visual slide to display to the student, the lesson application displays the information, steps 620 and 622. If a step requires the acquisition of data from the sensor probe 102, the lesson application issues commands to the sensor probe 102 via the receiver module 104 to acquire data, steps 622 and 624. If called for by the lesson module, the lesson application may also display an assessment question or prompt the student for further input before continuing to the next step, steps 628, 630, and 632.

The lesson application 108 may also track the time taken by students to progress through a lesson module. The lesson application software 108 may also track and display the student's progress through a lesson module or provide other indications of status pertaining to the lesson module. As the lesson module progresses, the lesson application 108 may also compute an evaluation of the student's performance on the lesson. The evaluation may be transferred or uploaded to the lesson database along with all sensor and student input data collected by the lesson application 108 during the progress of the lesson module, step 640.

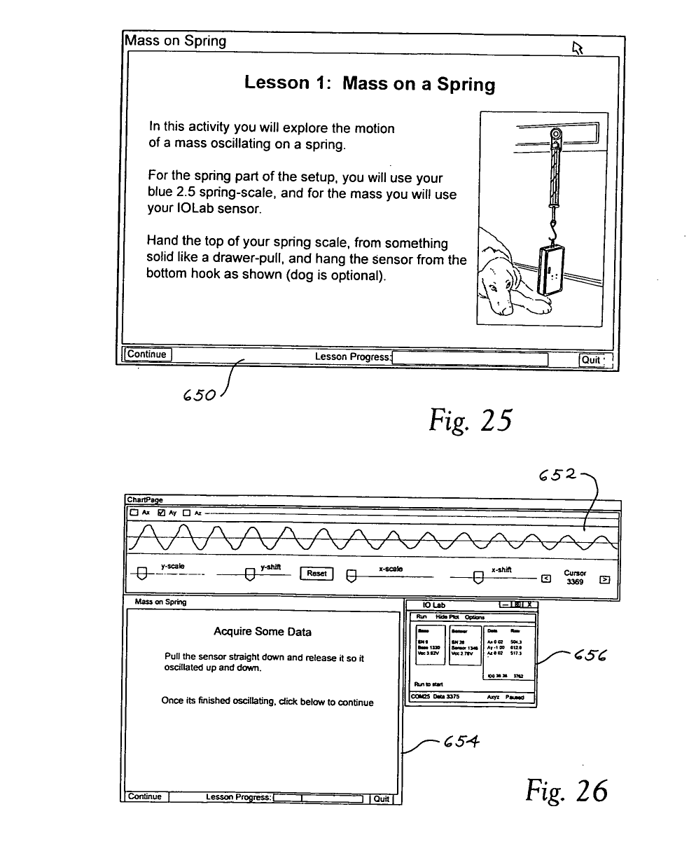

An illustrative lesson flow showing the operation of the software component 108 will now be described for a student who has selected a lesson module on exploring the motion of a mass oscillating on a spring. The lesson application 108 displays an introduction to the laboratory activity such as shown as 650 in FIG. 25 and instructs the student to hang the sensor probe 102 from a 2.5N spring scale. After the lesson application 108 detects that the student has chosen to continue to the next step, the lesson application then displays an instruction 654 to the student to oscillate the sensor probe 102 at the end of the spring such as shown in FIG. 26. At the same time, the lesson application issues commands to the sensor probe 102 through the receiver module 104 to begin recording accelerometer measurements at the rate of 100 measurements per second. Data obtained from by the accelerometer sensor in the sensor probe 102 is passed through receiver module 104 to the lesson application 108, which records and plots the measurements for review by the student, shown in 652.

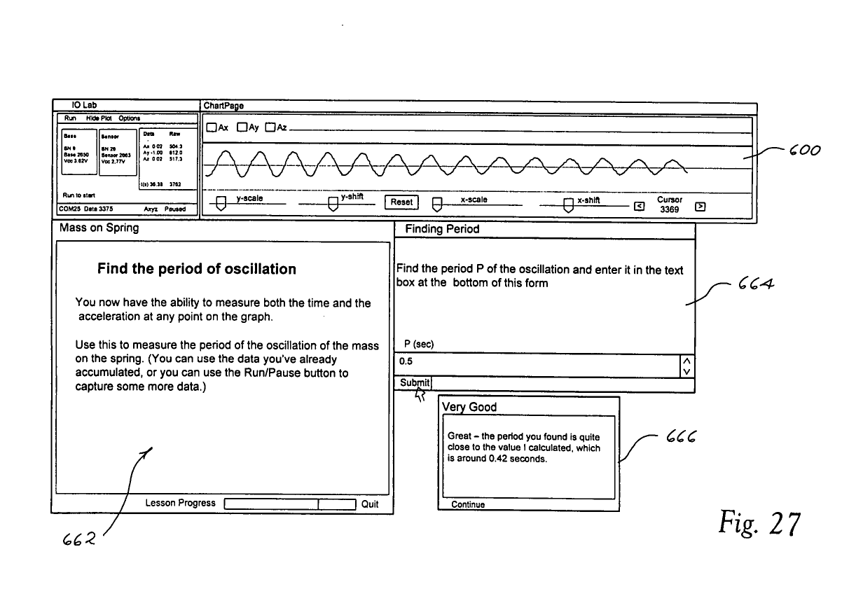

During a portion of the lesson module, the student may be instructed to perform an assessment and respond correctly to a question prompt. In the example as shown in FIG. 27, the lesson application 108 displays the measurements recorded earlier in the lesson module as shown in 660 and prompts the student to calculate the period of oscillation as shown in 662. Through the lesson application 108, the student can manipulate and adjust the displayed sensor plot to measure the distance between points. When the student calculates the period of oscillation and enters it into the prompt as shown in 664, the lesson application 108 compares the student's response with the actual correct answer calculated from the sensor data by the lesson application 108. An evaluation of the student's response to the assessment question is displayed as shown in 666. In the example displayed in FIG. 27, the student's response of 0.5 seconds is close to the actual value of 0.42 seconds calculated by the lesson application 108 from the acquired sensor data. As previously described, the student's data and performance records can be uploaded and stored on a remote database or server for later access and usage by students, instructors, or course management systems.

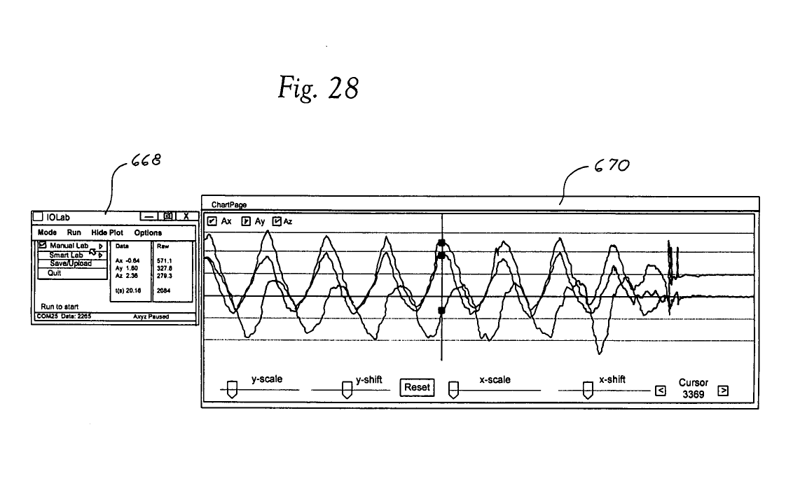

In addition to preplanned lesson modules, the lesson application 108 may also permit a “manual lab” mode as shown as 668 in FIG. 28. In manual mode, the lesson application 108 can be used to acquire sensor data from sensor probe 102 and display the results as shown as 670 for review by the student. In this way, students can make up their own experiment and use the full capabilities of the interactive laboratory kit 100 to make any measurement desired.

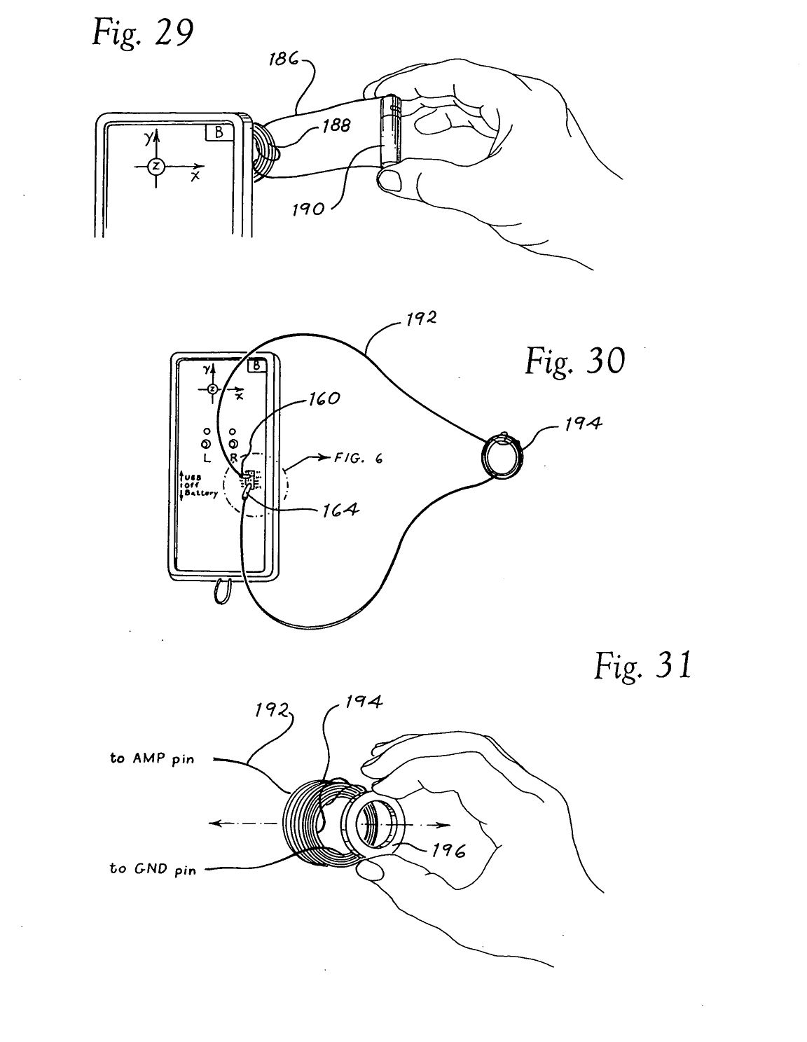

The interactive laboratory kit 100 may also be used to perform experiments surrounding magnetic fields and testing such scientific laws as Faraday's Law and the Bio Savart Law. One experiment may instruct the student to test a magnetic field generated from a loop of current in a wire. Referring to FIG. 29, the magnetic field experiment includes a setup having a wire 186 with a loop portion 188 being connected to both terminals of a battery 190. The student will use magnetic field magnitudes to make calculations pertaining to the experiment. The student will therefore select the “Magnetic Field” experiment at the interactive interface causing initiation of the magnetic field or Hall Effect sensors 134. Once the setup is complete, the student may begin the magnetic field experiment by sliding the loop portion 188 of wire under the front corner of the probe 102 where the Hall Effect sensors 134 are located. The sensors 134 collect magnetic field data relating to the magnetic field induced by the current that is transmitted to the computer 106 via the receiver module 104. The software component 108 processes the collected magnetic field data and calculates resulting magnetic field magnitudes from the collected data for presentation to the student at the display 110.

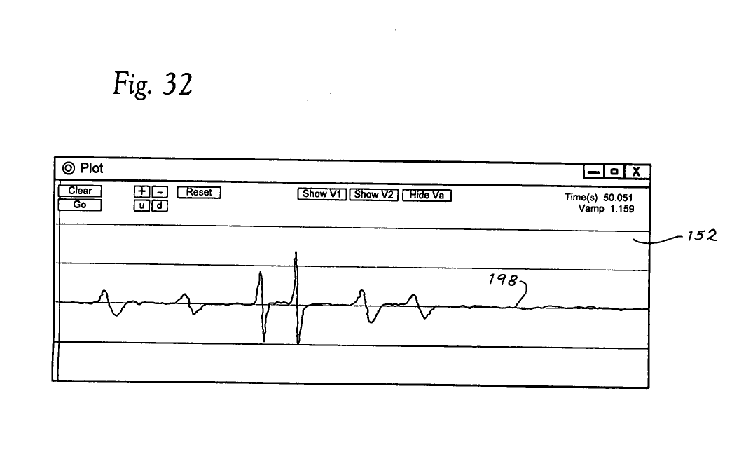

Another interactive experiment test the student's ability to measure small voltages generated by a wire 192 having a loop 194 to investigate Faraday's law. As shown in FIG. 30, the setup for the voltage input experiment includes two ends of the looped wire 192 connected to the AMP and GND voltage pins 160, 164. The student will select “Voltage Inputs” from the interactive interface to initiate the voltage input 142. Once setup is complete, the student may hold a magnet 196 horizontally and in an orientation such that the North pole is pointing down. As shown in FIG. 31, the student may wave the magnet 196 back and forth over the wired loop 194 at first slowly and then at a faster rate causing a current to be induced through the wire 192 and thereby creating a voltage across the plurality of voltage pins 142. The plurality of voltage pins 142 will sense and collect data associated with the generated voltage. The collected voltage data is transmitted to the computer 106 and processed by the software component 108 and the calculated voltage values at different times during the experiment are presented as display trace 198 as shown in the plot window 152 of FIG. 32. The student may be asked to answer questions relating to the particular data trace 198, make an analysis regarding the trace 198, or acquire more data by performing more experiments.

As discussed herein, it is contemplated that additional sensors may be included at the sensor probe 102 for performing a variety of interactive experiments. The foregoing description and the drawings are illustrative of the present invention and not to be taken as limiting. Other arrangements of the engagement structure may be implemented. Such variations and modifications are within the spirit and the scope of the present invention and will be readily apparent to those skilled in the art in view of the scope of the invention as claimed herein.

What is claimed is:

1. A teaching kit for performing a plurality of interactive experiments comprising:
a wireless sensor probe having a plurality of sensors including an accelerometer for collecting acceleration data associated with movement of the probe, a magnetic field sensor for collecting magnetic field data associated with a magnetic field proximate the probe, a voltage input sensor for collecting voltage data associated with an external voltage source adapted to be connected to the probe, and an ultrasonic sensor for collecting distance data associated with an object spaced a distance from the probe, wherein each of the plurality of sensors is adapted for generating a signal associated with each of the respective data;
a receiver module for receiving the signals associated with each of the respective data from the wireless sensor probe; and
a software storage means for receiving the signals associated with the respective data from the receiver module, the software storage means including software adapted for executing multiple sets of instructions, each set of instructions correlating with at least one of the plurality of interactive experiments and selected in response to actuation of a selected sensor of one of the plurality of sensors;
wherein each set of instructions selectively processes the received signals associated with the respective data for calculating a magnitude relating to at least one of the acceleration associated with the movement of the probe, the magnetic field proximate the probe, the voltage of the external voltage source connected to the probe, and the distance spaced between the object and the probe;
wherein each set of instructions is adapted for generating graphical output associated with the respective calculated magnitude for visual representation at a display.

2. An interactive laboratory for performing a plurality of interactive experiments comprising:
a wireless sensor probe having at least two sensors selected from a group comprising an accelerometer for collecting acceleration data associated with movement of the probe, a magnetic field sensor for collecting magnetic field data associated with a magnetic field proximate the probe, a voltage input sensor for collecting voltage data associated with an external voltage source adapted to be connected to the probe, and an ultrasonic sensor for collecting distance data associated with an object spaced a distance from the probe, wherein each the at least one sensor is adapted for generating a signal associated with each of the respective data;
a receiver module for receiving the signals associated with each of the respective data from the wireless sensor probe; and
a software storage means for receiving the signals associated with the respective data from the receiver module, the software storage means including software adapted for executing multiple sets of instructions, each set of instructions correlating with at least one of the plurality of interactive experiments and selected in response to actuation of a selected sensor of one of the plurality of sensors;
wherein each set of instructions selectively processes the received signals associated with the respective data for calculating a magnitude relating to at least one of the acceleration associated with the movement of the probe, the magnetic field proximate the probe, the voltage of the external voltage source connected to the probe, and the distance spaced between the object and the probe;
wherein each set of instructions is adapted for generating graphical output associated with the respective calculated magnitude for visual representation at a display.

3. The interactive laboratory of claim 2 wherein the wireless sensor probe further comprises a microcontroller adapted for converting the collected data from an analog to digital format.

4. The interactive laboratory of claim 2 wherein the wireless sensor probe further comprises a transmitter adapted for transmitting the collected data to the receiver module.

5. The interactive laboratory of claim 2 wherein each set of instructions selectively processes the received signals associated with the respective data for calculating values relating to velocity associated with the movement of the probe.

6. The interactive laboratory of claim 2 wherein each set of instructions selectively processes the received signals associated with the respective data for calculating values relating to displacement associated with the movement of the probe.

7. The interactive laboratory of claim 2 wherein the software is adapted for executing an application program for providing an interactive interface on a computer.

8. An interactive laboratory for performing a plurality of interactive experiments comprising:
a wireless sensor probe having at least two sensors each constructed and arranged for collecting data associated with physical characteristics at times during the course of an interactive experiment and adapted for generating signals associated with the collected data;
a receiver module for receiving the signals associated with the respective data from the at least two sensors; and
a software storage for receiving the signals associated with the collected data from the receiver module, the software storage including software adapted for executing multiple sets of instructions, each set of instructions correlating with at least one of the plurality of interactive experiments and selected in response to actuation of a selected sensor of the at least two sensors;
wherein each set of instructions selectively processes the received signals associated with the collected data for calculating magnitudes associated with the physical characteristics associated with the selected sensor;
wherein each set of instructions is adapted for generating graphical output associated with the calculated magnitudes at times during the course of the experiment for visual representation at a display.

9. The interactive laboratory of claim 8 wherein at least one of the at least two sensors is an accelerometer adapted for collecting data associated with the movement of the probe.

10. The interactive laboratory of claim 8 wherein the at least one of the at least two sensors is a Hall Effect sensor for collecting data associated with a magnetic field proximate the sensor probe.

11. The interactive laboratory of claim 8 wherein the at least one of the at least two sensors is a voltage input for collecting voltage data associated with an external voltage source connected to the sensor probe.

12. The interactive laboratory of claim 8 wherein the at least one of the at least two sensors is an ultrasonic sensor for collecting distance data associated with an object spaced a distance from the sensor probe.

13. The interactive laboratory of claim 8 wherein the at least one of the at least two sensors is an ultrasonic sensor for collecting distance data associated with the distance between the receiver module and the sensor probe.

14. The interactive laboratory of claim 8 wherein the sensor probe further comprises a transmitter for operatively transmitting the collected data to the receiver module approximately 100 times per second.

15. The interactive laboratory of claim 8 wherein each set of instructions selectively processes the received signals associated with the collected data for calculating magnitudes associated with the acceleration the sensor probe.

16. The interactive laboratory of claim 8 wherein each set of instructions selectively processes the received signals associated with the collected data for calculating magnitudes associated with magnetic fields proximate the sensor probe.

17. The interactive laboratory of claim 8 wherein each set of instructions selectively processes the received signals associated with the collected data for calculating magnitudes associated with a voltage of the external voltage source connected to the probe.

18. The interactive laboratory of claim 8 wherein each set of instructions selectively processes the received signals associated with the collected data for calculating magnitudes associated with a distance spaced between the object and the probe.

19. The teaching kit of claim 2 wherein the voltage input sensor of the wireless sensor probe may be adapted to be connected to an external sensor.
